(19) United States
(12) Patent Application Publication
(10) Pub. No.: US 2016/0061051 A1
(43) Pub. Date: Mar. 3, 2016

(54) GEARED TURBOFAN WITH THREE TURBINES WITH HIGH SPEED FAN DRIVE TURBINE

(71) Applicant: United Technologies Corporation, Hartford, CT (US)

(72) Inventors: Frederick M. Schwarz, Glastonbury, CT (US); Daniel Bernard Kupratis, Wallingford, CT (US)

(21) Appl. No.: 14/934,228

(22) Filed: Nov. 6, 2015

Related U.S. Application Data
(63) Continuation-in-part of application No. 13/484,589, filed on May 31, 2012.

(51) Int. Cl. F01D 15/12; F01D 17/10; F01D 5/06

(52) U.S. Cl. CPC F01D 15/12; F01D 5/06; F01D 17/105; F05D 2220/32; F05D 2230/60; F05D 2240/24; F05D 2260/40311

(57) ABSTRACT

A gas turbine engine according to an example of the present disclosure includes a fan section includes, among other things, a fan, a first compressor section, and a second compressor section configured to compress air to a higher pressure than the first compressor section. A first turbine section is configured to drive the second compressor section. A second turbine section is configured to drive the first compressor section. A fan drive turbine section is positioned downstream of the second turbine section. The fan drive turbine section is configured to drive the fan section through a gear reduction. The fan drive turbine section has a first exit area at a first exit point and is configured to rotate at a first speed. The second turbine section has a second exit area at a second exit point and is configured to rotate at a second speed, which is faster than the first speed. A first performance quantity is defined as the product of the first speed squared and the first area. A second performance quantity is defined as the product of the second speed squared and the second area.

### CROSS REFERENCE TO RELATED APPLICATION

This application is a continuation-in-part of U.S. application Ser. No. 13/484,589, filed 31 May 2012.

### BACKGROUND

This application relates to a gas turbine having three turbine sections, with one of the turbine sections driving a fan through a gear change mechanism.

Gas turbine engines are known, and typically include a compressor section compressing air and delivering the compressed air into a combustion section. The air is mixed with fuel and combusted, and the product of that combustion passes downstream over turbine rotors.

In one known gas turbine engine architecture, there are two compressor rotors in the compressor section, and three turbine rotors in the turbine section. A highest pressure turbine rotates a highest pressure compressor. An intermediate pressure turbine rotates a lower pressure compressor, and a third turbine is a fan drive turbine which drives the fan.

### SUMMARY

A gas turbine engine according to an example of the present disclosure includes a fan section including a fan, a first compressor section, and a second compressor section configured to compress air to a higher pressure than the first compressor section. A first turbine section is configured to drive the second compressor section. A second turbine section is configured to drive the first compressor section. A fan drive turbine section is positioned downstream of the second turbine section. The fan drive turbine section is configured to drive the fan section through a gear reduction. The first compressor section and the second turbine section are configured to rotate as an intermediate speed spool, and the second compressor section and the first turbine section are configured to rotate together as a high speed spool, with the high speed spool, the intermediate speed spool, and the fan drive turbine section each configured to rotate in a first direction. The fan drive turbine section has a first exit area at a first exit point and is configured to rotate at a first speed. The second turbine section has a second exit area at a second exit point and is configured to rotate at a second speed, which is faster than the first speed. A first performance quantity is defined as the product of the first speed squared and the first area. A second performance quantity is defined as the product of the second speed squared and the second area. A ratio of the first performance quantity to the second performance quantity is less than or equal to about 1.5.

In a further embodiment of any of the forgoing embodiments, the gear reduction is configured to cause the fan section to rotate in the first direction.

In a further embodiment of any of the forgoing embodiments, the ratio is above or equal to about 0.8.

In a further embodiment of any of the forgoing embodiments, the fan drive turbine section has at least three stages.

In a further embodiment of any of the forgoing embodiments, a pressure ratio across the fan drive turbine section is greater than about 5:1.

In a further embodiment of any of the forgoing embodiments, a bypass ratio is defined for the fan section, as a ratio of the amount of air delivered into a bypass path divided by the amount of air delivered to the first compressor section, and the bypass ratio is greater than about 10.

In a further embodiment of any of the forgoing embodiments, a gear reduction ratio of the gear reduction is greater than or equal to about 2.5.

In a further embodiment of any of the forgoing embodiments, the first turbine section has one or two stages.

In a further embodiment of any of the forgoing embodiments, the fan drive turbine section has between two and six stages.

In a further embodiment of any of the forgoing embodiments, a low fan pressure ratio is defined as the ratio of total pressure across the fan alone, before any fan exit guide vanes, and the low fan pressure ratio is less than about 1.50.

A gas turbine engine according to an example of the present disclosure includes a fan section including a fan, a first compressor section and a second compressor section. The second compressor section is configured to compress air to a higher pressure than the first compressor section. A first turbine section is configured to drive the second compressor section. A second turbine section is configured to drive the first compressor section. A fan drive turbine section is positioned downstream of the second turbine section. The fan drive turbine section is configured to drive the fan section through a gear reduction. A pressure ratio across the fan drive turbine section is greater than about 5:1. The first compressor section and the second turbine section rotate as an intermediate speed spool. The second compressor section and the first turbine section rotate together as a high speed spool, with the high speed spool, the intermediate speed spool, and the fan drive turbine section configured to rotate in a first direction. The gear reduction is configured to cause the fan section to rotate in the first direction. The fan drive turbine section has a first exit area at a first exit point and is configured to rotate at a first speed. The second turbine section has a second exit area at a second exit point and is configured to rotate at a second speed, which is faster than the first speed. A first performance quantity is defined as the product of the first speed squared and the first area. A second performance quantity is defined as the product of the second speed squared and the second area. A ratio of the first performance quantity to the second performance quantity is less than or equal to about 1.5.

In a further embodiment of any of the forgoing embodiments, the ratio is above or equal to about 0.8.

In a further embodiment of any of the forgoing embodiments, the fan drive turbine section has between two and six stages.

In a further embodiment of any of the forgoing embodiments, the ratio is above or equal to about 0.5. The fan drive turbine section has at least three stages.

In a further embodiment of any of the forgoing embodiments, a bypass ratio is defined for the fan section, as a ratio of the amount of air delivered into a bypass path divided by the amount of air delivered to the first compressor section, and the bypass ratio is greater than about 10.

In a further embodiment of any of the forgoing embodiments, a gear reduction ratio of the gear reduction is greater than about 2.5.

In a further embodiment of any of the forgoing embodiments, the first turbine section has one or two stages.

A method of designing a gas turbine engine according to an example of the present disclosure includes providing a fan section, providing a compressor section in fluid communication with the fan section, including a first compressor section upstream of a second compressor section, and providing a first turbine section, a second turbine section, and a fan drive turbine section positioned downstream of the second turbine section. The first turbine section is configured to drive the second compressor section. The second turbine section is configured to drive the first compressor section, and the fan drive turbine section is configured to drive the fan section through a gear reduction. The first compressor section and the second turbine section are configured to rotate as an intermediate speed spool, and the second compressor section and the first turbine section are configured to rotate together as a high speed spool. The fan drive turbine section has a first exit area at a first exit point and is configured to rotate at a first speed. The second turbine section has a second exit area at a second exit point and is configured to rotate at a second speed, which is faster than the first speed. A first performance quantity is defined as the product of the first speed squared and the first area at a predetermined design target. A second performance quantity is defined as the product of the second speed squared and the second area at a predetermined design target, and a ratio of the first performance quantity to the second performance quantity is between about 0.8 and about 1.5.

In a further embodiment of any of the forgoing embodiments, the predetermined design target corresponds to a takeoff condition.

In a further embodiment of any of the forgoing embodiments, an overall pressure ratio is provided by the combination of a pressure ratio across the first compressor section and a pressure ratio across the second compressor section at the predetermined design target, and the overall pressure ratio is greater than or equal to about 35.

These and other features of the invention would be better understood from the following specifications and drawings, the following of which is a brief description.

### BRIEF DESCRIPTION OF THE DRAWINGS

FIG. 1 schematically shows a gas turbine engine.

FIG. 2 shows exit areas in a schematic engine.

### DETAILED DESCRIPTION

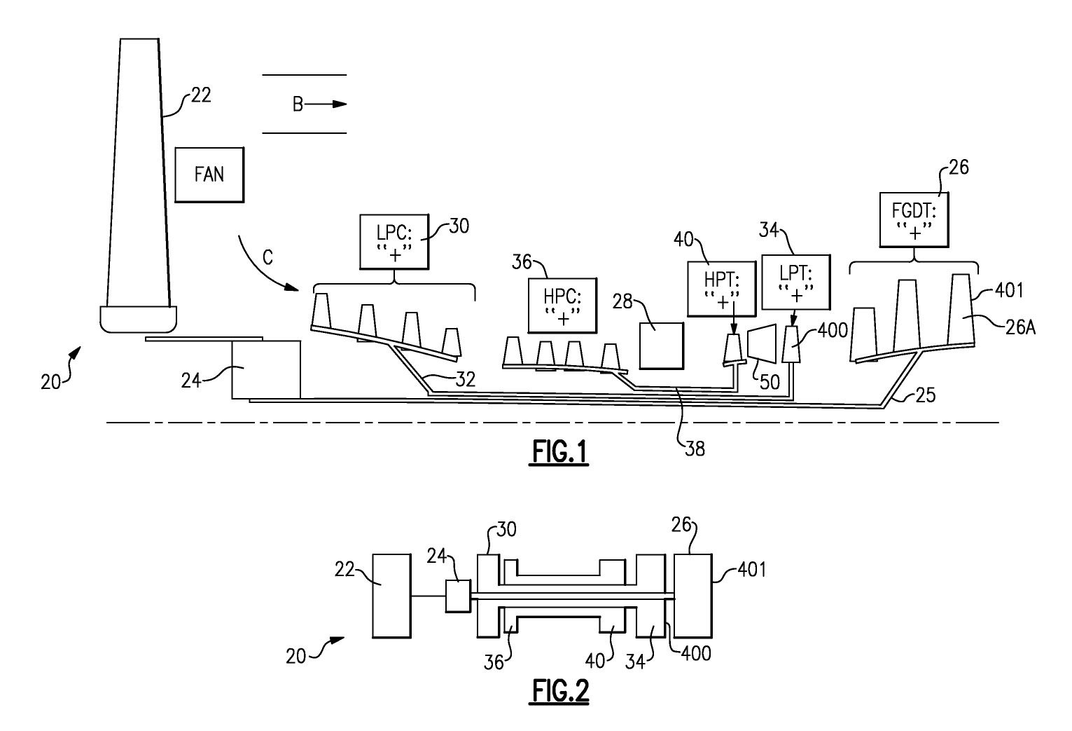

A gas turbine engine 20 is illustrated in FIG. 1, and incorporates a fan 22 driven through a gear reduction 24. The gear reduction 24 is driven with a low speed spool 25 by a fan/gear drive turbine (“FGDT”) 26. Air is delivered from the fan as bypass air B, and into a low pressure compressor 30 as core air C. The air compressed by the low pressure compressor 30 passes downstream into a high pressure compressor 36, and then into a combustion section 28. From the combustion section 28, gases pass across a high pressure turbine 40, low pressure turbine 34, and fan drive turbine 26. In the illustrated example, low pressure compressor 30 has the same number of stages as the high pressure compressor 36. In other examples, the low pressure compressor 30 includes fewer stages than the high pressure compressor 36.

A plurality of vanes and stators 50 may be mounted between the several turbine sections. In particular, as shown, the low pressure compressor 30 rotates with an intermediate pressure spool 32 and the low pressure turbine 34 in a first (“+”) direction. The fan drive turbine 26 rotates with a shaft 25 in the same (“+”) direction as the low pressure spool 32. The speed change gear 24 may cause the fan 22 to rotate in the first (“+”) direction. However, the fan rotating in the opposed direction (the second direction) would come within the scope of this invention. As is known within the art, a star gear arrangement may be utilized for the fan to rotate in an opposite direction as to the fan/gear drive turbine 26. On the other hand, a planetary gear arrangement may be utilized, wherein the two rotate in the same direction. The high pressure compressor 36 rotates with a spool 38 and is driven by a high pressure turbine 40 in the first direction (“+”).

Since the turbines 26, 34 and 40 are rotating in the same direction, a first type of vane 50 is incorporated between these three sections. Vane 50 may be a highly cambered vane, and may be used in combination with a mid-turbine frame. The vane 50 may be incorporated into a mid-turbine frame as an air turning mid-turbine frame (“TMTF”) vane.

The fan drive turbine 26 in this arrangement can operate at a higher speed than other fan drive turbine arrangements. The fan drive turbine can have shrouded blades, which provides design freedom.

The low pressure compressor may have more than three stages. The fan drive turbine has at least two, and up to six stages. The high pressure turbine as illustrated may have one or two stages, and the low pressure turbine may have one or two stages.

An exit area 400 is shown, in FIGS. 1 and 2, at the exit location for the low pressure turbine section 34 is the annular area of the last blade of turbine section 34. An exit area for the fan drive turbine section 26 is defined at exit 401, and is the annular area defined by the last blade of that turbine section 26. With this arrangement, and with the other structure as set forth above, including the various quantities and operational ranges, a very high speed can be provided to the low pressure spool. Turbine section operation is often evaluated looking at a performance quantity, which is the exit area for the turbine section multiplied by its respective speed squared. This performance quantity (“PQ”) is defined as:

PQ_{fdt}=(A_{fdt}×V_{fdt}²) Equation 1:

PQₗₚₜ=(Aₗₚₜ×Vₗₚₜ²) Equation 2:

where A_{fdt} is the area of the fan drive turbine section at the exit thereof (e.g., at 401), where V_{fdt} is the speed of the fan drive turbine section, where Aₗₚₜ is the area of the low pressure turbine section at the exit thereof (e.g., at 400), and where Vₗₚₜ is the speed of the low pressure turbine section.

Thus, a ratio of the performance quantity for the fan drive turbine section compared to the performance quantify for the low pressure turbine section is:

(A_{fdt}×V_{fdt}²)/(Aₗₚₜ×Vₗₚₜ²)=PQ_{fdt/}PQₗₚₜ Equation3:

In one turbine embodiment made according to the above design, the areas of the fan drive and low pressure turbine sections are 557.9 in² and 90.67 in², respectively. Further, the speeds of the fan drive and low pressure turbine sections are 10179 rpm and 24346 rpm, respectively. Thus, using Equations 1 and 2 above, the performance quantities for the fan drive and low pressure turbine sections are:

PQ_{fdt}=(A_{fdt}×V_{fdt}²)=(557.9 in²)(10179rpm)²=57805157673.9in²rpm² Equation 1:

PQₕₚₜ=(Aₗₚₜ×Vₗₚₜ²)=(90.67 in²)(24346rpm)²=53742622009.72in²rpm² Equation 2:

and using Equation 3 above, the ratio for the low pressure turbine section to the high pressure turbine section is:

Ratio=PQ_{fdt/}PQₗₚₜ=57805157673.9 in² rpm²/53742622009.72 in² rpm²=1.075

In another embodiment, the ratio was about 0.5 and in another embodiment the ratio was about 1.5. With PQ_{fdt/}PQₗₚₜ ratios in the 0.5 to 1.5 range, a very efficient overall gas turbine engine is achieved. More narrowly, PQ_{fdt/}PQₗₚₜ ratios of above or equal to about 0.8 are more efficient. Even more narrowly, PQ_{fdt/}PQₗₚₜ ratios above or equal to 1.0 are even more efficient. As a result of these PQ_{fdt/}PQₗₚₜ ratios, in particular, the turbine section can be made much smaller than in the prior art, both in diameter and axial length. In addition, the efficiency of the overall engine is greatly increased.

In some examples, engine 20 is designed at a predetermined design target defined by performance quantities for the low pressure turbine 34 and fan/gear drive turbine section 26. In further examples, the predetermined design target is defined by pressure ratios of the low pressure and high pressure compressors 30, 36.

In some examples, the overall pressure ratio corresponding to the predetermined design target is greater than or equal to about 35:1. That is, after accounting for a pressure rise of the fan section 22 in front of the low pressure compressor 30, the pressure of the air entering the low pressure compressor 30 should be compressed as much or over 35 times by the time it reaches an outlet of the high pressure compressor 36. In other examples, an overall pressure ratio corresponding to the predetermined design target is greater than or equal to about 40:1, or greater than or equal to about 50:1. In some examples, the overall pressure ratio is less than about 70:1, or more narrowly less than about 50:1. In some examples, the predetermined design target is defined at sea level and at a static, full-rated takeoff power condition. In other examples, the predetermined design target is defined at a cruise condition.

The engine 20 is a high-bypass geared aircraft engine. The bypass ratio is the amount of air delivered into bypass path B divided by the amount of air into core path C. In a further example, the engine 20 bypass ratio is greater than about six (6) and less than about thirty (30), or more narrowly less than about twenty (20), with an example embodiment being greater than ten (10), the geared architecture 24 is an epicyclic gear train, such as a planetary gear system or other gear system, with a gear reduction ratio of greater than about 2.3 and the fan/gear drive turbine section 26 has a pressure ratio that is greater than about 5. In some embodiments, the gear reduction ratio is less than about 5.0, or less than about 4.0. In one disclosed embodiment, the engine 20 bypass ratio is greater than about ten (10:1), the fan diameter is significantly larger than that of the low pressure compressor section 30, and the fan/gear drive turbine section 26 has a pressure ratio that is greater than about 5:1. In some embodiments, fan/gear drive turbine section 26 has a pressure ratio that is less than about 20:1, or less than about 10:1. In some embodiments, the high pressure turbine section 40 may have two or fewer stages. In contrast, the fan/gear drive turbine section 26, in some embodiments, has between two and six stages. Further the fan/gear drive turbine section 26 pressure ratio is total pressure measured prior to inlet of fan/gear drive turbine section 26 as related to the total pressure at the outlet of the fan/gear drive turbine section 26 prior to an exhaust nozzle. The geared architecture 24 may be an epicycle gear train, such as a planetary gear system or other gear system, with a gear reduction ratio of greater than or equal to about 2.5:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (“TSFC”). TSFC is the industry standard parameter of the rate of lbm of fuel being burned per hour divided by lbf of thrust the engine produces at that flight condition. “Low fan pressure ratio” is the ratio of total pressure across the fan blade alone, before the fan exit guide vanes. The low fan pressure ratio as disclosed herein according to one non-limiting embodiment is less than about 1.50, or more narrowly less than about 1.45. “Low corrected fan tip speed” is the actual fan tip speed in ft/sec divided by an industry standard temperature correction of [(Ram Air Temperature deg R)/518.7)̂0.5]. The “Low corrected fan tip speed” as disclosed herein according to one non-limiting embodiment is less than about 1150 ft/second. Further, the fan 22 may have 26 or fewer blades.

Engines made with the disclosed architecture, and including turbine sections as set forth in this application, and with modifications coming from the scope of the claims in this application, thus provide very high efficient operation, and increased fuel efficiency and lightweight relative to their thrust capability.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A gas turbine engine comprising:
a fan section including a fan, a first compressor section, and a second compressor section configured to compress air to a higher pressure than said first compressor section;
a first turbine section configured to drive said second compressor section;
a second turbine section configured to drive said first compressor section;
a fan drive turbine section positioned downstream of said second turbine section, said fan drive turbine section configured to drive said fan section through a gear reduction;
wherein said first compressor section and said second turbine section are configured to rotate as an intermediate speed spool, and said second compressor section and said first turbine section are configured to rotate together as a high speed spool, with said high speed spool, said intermediate speed spool, and said fan drive turbine section each configured to rotate in a first direction;
wherein said fan drive turbine section has a first exit area at a first exit point and is configured to rotate at a first speed, said second turbine section has a second exit area at a second exit point and is configured to rotate at a second speed, which is faster than the first speed; and
wherein a first performance quantity is defined as the product of the first speed squared and the first area, a second performance quantity is defined as the product of the second speed squared and the second area, and a ratio of the first performance quantity to the second performance quantity is less than or equal to about 1.5.

2. The engine as set forth in claim 1, wherein said gear reduction is configured to cause said fan section to rotate in said first direction.

3. The engine as set forth in claim 1, wherein said ratio is above or equal to about 0.8.

4. The engine as set forth in claim 1, wherein said fan drive turbine section has at least three stages.

5. The engine as set forth in claim 4, wherein a pressure ratio across said fan drive turbine section is greater than about 5:1.

6. The engine as set forth in claim 1, wherein a bypass ratio is defined for said fan section, as a ratio of the amount of air delivered into a bypass path divided by the amount of air delivered to said first compressor section, and said bypass ratio being greater than about 10.

7. The engine as set forth in claim 1, wherein a gear reduction ratio of the gear reduction is greater than or equal to about 2.5.

8. The engine as set forth in claim 1, wherein said first turbine section has one or two stages.

9. The engine as set forth in claim 1, wherein said fan drive turbine section has between two and six stages.

10. The engine as set forth in claim 9, wherein a low fan pressure ratio is defined as the ratio of total pressure across the fan alone, before any fan exit guide vanes, and said low fan pressure ratio is less than about 1.50.

11. A gas turbine engine comprising:
a fan section including a fan, a first compressor section and a second compressor section, said second compressor section configured to compress air to a higher pressure than said first compressor section;
a first turbine section configured to drive said second compressor section;
a second turbine section configured to drive said first compressor section;
a fan drive turbine section positioned downstream of said second turbine section, said fan drive turbine section configured to drive said fan section through a gear reduction, a pressure ratio across said fan drive turbine section being greater than about 5:1;
said first compressor section and said second turbine section rotating as an intermediate speed spool, said second compressor section and said first turbine section rotating together as a high speed spool, with said high speed spool, said intermediate speed spool, said fan drive turbine section configured to rotate in a first direction, and said gear reduction configured to cause said fan section to rotate in said first direction;
wherein said fan drive turbine section has a first exit area at a first exit point and is configured to rotate at a first speed, said second turbine section has a second exit area at a second exit point and is configured to rotate at a second speed, which is faster than the first speed; and
wherein a first performance quantity is defined as the product of the first speed squared and the first area, a second performance quantity is defined as the product of the second speed squared and the second area, and a ratio of the first performance quantity to the second performance quantity is less than or equal to about 1.5.

12. The engine as set forth in claim 11, wherein said ratio is above or equal to about 0.8.

13. The engine as set forth in claim 11, wherein said fan drive turbine section has between two and six stages.

14. The engine as set forth in claim 11, wherein:
said ratio is above or equal to about 0.5; and
said fan drive turbine section has at least three stages.

15. The engine as set forth in claim 14, wherein a bypass ratio is defined for said fan section, as a ratio of the amount of air delivered into a bypass path divided by the amount of air delivered to said first compressor section, and said bypass ratio being greater than about 10.

16. The engine as set forth in claim 15, wherein a gear reduction ratio of the gear reduction is greater than about 2.5.

17. The engine as set forth in claim 16, wherein said first turbine section has one or two stages.

18. A method of designing a gas turbine engine, comprising:
providing a fan section;
providing a compressor section in fluid communication with said fan section, including a first compressor section upstream of a second compressor section;
providing a first turbine section, a second turbine section, and a fan drive turbine section positioned downstream of said second turbine section, said first turbine section configured to drive said second compressor section, said second turbine section configured to drive said first compressor section, and said fan drive turbine section configured to drive said fan section through a gear reduction;
wherein said first compressor section and said second turbine section are configured to rotate as an intermediate speed spool, and said second compressor section and said first turbine section are configured to rotate together as a high speed spool;
wherein said fan drive turbine section has a first exit area at a first exit point and is configured to rotate at a first speed, said second turbine section has a second exit area at a second exit point and is configured to rotate at a second speed, which is faster than the first speed; and
wherein a first performance quantity is defined as the product of the first speed squared and the first area at a predetermined design target, a second performance quantity is defined as the product of the second speed squared and the second area at a predetermined design target, and a ratio of the first performance quantity to the second performance quantity is between about 0.8 and about 1.5.

19. The method as set forth in claim 18, wherein the predetermined design target corresponds to a takeoff condition.

20. The method as set forth in claim 18, wherein an overall pressure ratio is provided by the combination of a pressure ratio across said first compressor section and a pressure ratio across said second compressor section at the predetermined design target, and the overall pressure ratio is greater than or equal to about 35.
